(19) United States
(12) Patent Application Publication
(10) Pub. No.: US 2007/0125708 A1
(43) Pub. Date: Jun. 7, 2007

(54) Wastewater treatment using spent solvents

(76) Inventor: David C. Brown, Miamisburg, OH (US)

Correspondence Address: Steven J. Rosen;Patent Attorney, 4729 Cornell Rd., Cincinnati, OH, 45241, US

(21) Appl. No.: 11/295,330

(22) Filed: Dec. 6, 2005

(51) Int. Cl. B01D 11/04

(52) U.S. Cl. 210/634; 210/739; 210/806

(57) ABSTRACT

A wastewater treatment method includes mixing spent solvents with an oily water stream comprising water, oil, and solids and separating a resulting mixture into a top layer of oil and solvent, a middle layer of clean water, and a bottom layer of solids. An exemplary embodiment of the method combines the spent solvents with the oily water stream at a 20-80% concentration by volume before or during the mixing. The top layer of oil and solvent is transported offsite into the fuels or commodity products markets and sending the bottom layer of solids offsite to a landfill. The clean water in the middle layer is tested for flashpoint, and if the clean water from the solvent process is found to have an acceptable flashpoint, it is further processed in a wastewater pre-treatment process and sent to a municipal water treatment plant for final treatment and discharge into the environment.

### BACKGROUND OF THE INVENTION

1. Field of the Invention

The invention relates to wastewater pre-treatment to separate used oil from water and solids and, more particularly, to using spent solvents in the pre-treatment process.

2. Background of the Invention

Used or spent solvents are treated as a hazardous waste, in part because of its flashpoint, and as such has conventionally been disposed of as a hazardous waste. Disposal of used solvents is typically accomplished by incineration at a tremendous cost to the generator of the used solvent. Thus, a less expensive and non-hazardous waste producing method is highly desirable.

Various methods, equipment, and systems are used or are known to treat industrial wastewater or oily water to separate mixtures of solids, oil, and water into divergent streams. This is an expensive but necessary process to maintain the quality of the environment and the handling of these wastewaters is very highly regulated by both federal and state governments. Methods are known for treating the wastewater and resolving it down to oil, rag (oil, solids, and water locked together) and water. The oil is typically sent out to be burned for fuel. The recovered oil can be sold to a reclaimer, remanufactured into hydraulic or cutting oil, or used as boiler fuel. The water is typically further treated and released into the environment at government controlled or municipal treatment plants.

### BRIEF DESCRIPTION OF THE INVENTION

A wastewater treatment process for separating oil from an oily water or wastewater mixture of solids, oil, and water uses spent or used solvents to separate or further separate oil from the water and solids. The wastewater and used solvent treatment process includes a used oil treatment process and a used solvent process. The wastewater treatment method includes mixing spent solvents with an oily water stream comprising water, oil, and solids and separating a resulting mixture into a top layer of oil and solvent, a middle layer of clean water, and a bottom layer of solids.

An exemplary embodiment of the method includes combining the spent solvents with the oily water stream at a 20-80% concentration by volume before or during the mixing, transporting the top layer of oil and solvent offsite into the fuels or commodity products markets (solvent, oil products), solidifying the bottom layer of solids for disposal at a landfill, and testing the clean water in the middle layer for flashpoint. If the clean water from the solvent process is found to have an acceptable flashpoint it undergoes a wastewater pre-treatment process and sent to a municipal water treatment plant for final treatment and discharge into the environment.

Another exemplary embodiment of the wastewater treatment method includes an oily water treatment process followed by a used solvent process. The oily water treatment process includes straining an untreated oily water stream and forming a strained oily water stream then testing the strained oily water stream to determine determine a best pre-treatment method that includes but is not limited to heat, chemical, and precipitation processes either alone or in combination. The strained oily water streams determined suitable are heated and/or chemically treated and then separated into at least three distinct layers. The three distinct layers including a top layer of clean oil, a middle layer comprising a mixture of water, oil, and solids, and a bottom layer of clean water. Difficult waste streams found to be not suitable for a pre-treatment process are separated and sent to the used solvent treatment process.

Next, in the used solvent process, spent solvents are mixed with the strained oily water stream deemed not suitable to be heat and/or chemically treated and/or the middle layer mixture of water, oil, and solids to form a mixture of used oils and solvents. The mixture of used oils and solvents is separated into a top layer of oil and solvent, a middle layer of clean water, and a bottom layer of solids. The top layer of oil and solvent are transported offsite into the fuels or commodity products markets. The clean water in the middle layer is tested for flashpoint and if the clean water from the solvent process is found have an acceptable flashpoint it is processed in a wastewater treatment process and sent to a municipal water treatment plant for final treatment and discharge into the environment. The solids in the bottom layer of solids are solidified and sent to a landfill.

### BRIEF DESCRIPTION OF THE DRAWINGS

The foregoing aspects and other features of the invention are explained in the following description, taken in connection with the accompanying drawings where:

FIG. 1 is a flow chart outlining an oily water treatment process of a wastewater treatment method using used solvents.

FIG. 2 is a flow chart outlining a used solvent process of the wastewater treatment method.

### DETAILED DESCRIPTION OF THE INVENTION

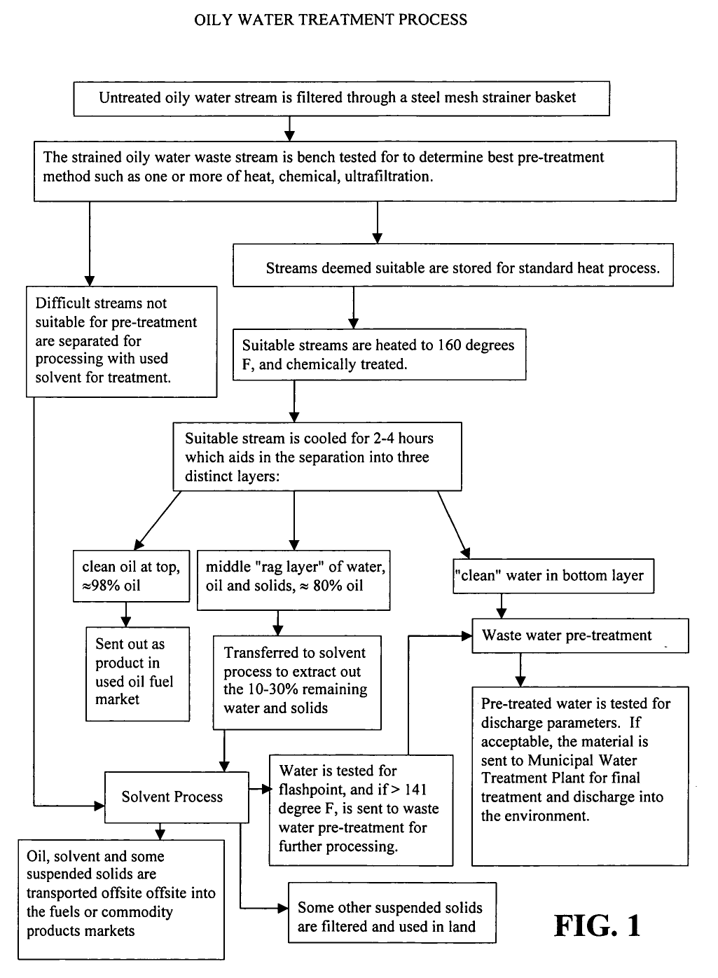

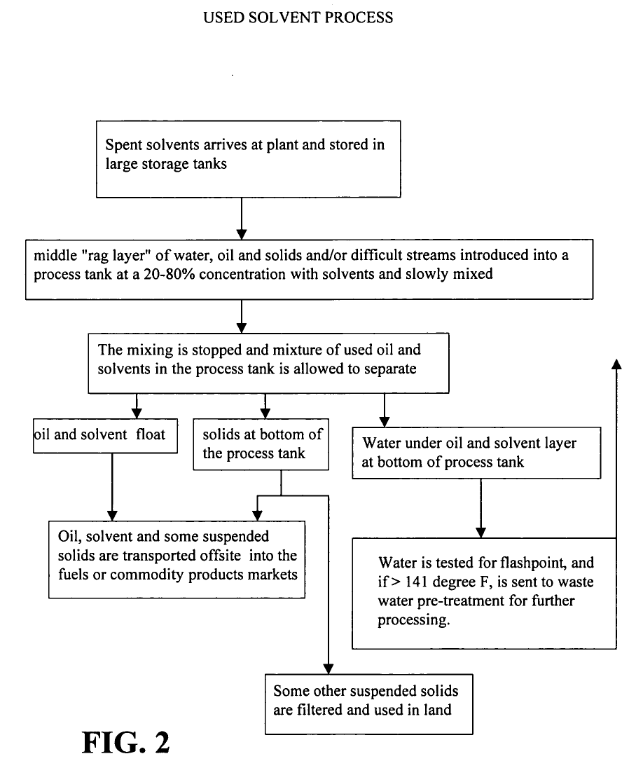

Illustrated in FIGS. 1 and 2 is a wastewater treatment method for separating oil from an oily water or wastewater mixture of solids, oil, and water and using spent or used solvents to separate or further separate oil from the water and solids. The wastewater and used solvent treatment process disclosed and claimed herein includes an oily water treatment process illustrated in FIG. 1 and a used solvent process illustrated in FIG. 2.

Oily Water Treatment Process

In the exemplary oily water treatment process, an untreated oily water stream is strained (filtered) through a steel mesh strainer basket with ¼ inch holes forming a strained oily water stream. Next, the strained oily water stream is bench tested to determine a best pre-treatment process or method which may include one or more of the following treatments heat, chemical, ultrafiltration, and precipitation and others that know in the industry. The strained oily water streams deemed treatable are stored for a standard heat process in which the treatable streams are heated to between 150 and 200 degrees F., and then may also be chemically treated. In the exemplary used oil treatment process disclosed herein, the treatable streams are heated to about 160 degrees F. The chemical treatment includes adding chemicals such as sulfuric acid and polymers to chemically break a suspension of oils from water in the oily water stream.

Difficult strained oily water streams, ones that are deemed not suitable for heat and/or chemical treatment, are separated and stored for treatment with spent solvents. The oily water streams deemed treatable are cooled for 2-24 hours allowing the heat and chemically treated waste oil to separate into three distinct layers. A top layer of “clean oil” containing about 98% oil. A middle layer, also referred to as a “rag layer” of water, oil, and solids containing about 50% oil. A bottom layer of “clean” water is at the bottom of the treatment tank.

The top layer of clean oil is sold and sent out as product to be used in the fuels or commodity products market. The bottom layer of “clean” water referred to herein as a clean water stream is sent through a wastewater pre-treatment process. After the clean water stream is passed through the wastewater pre-treatment process, it is tested for discharge parameters and if found acceptable, the processed clean water stream is sent to a municipal water treatment plant for final treatment and discharge into the environment. The middle or “rag” layer of water, oil, and solids is transferred to the solvent process to extract out the 20-50% remaining water and solids. So called “clean water” from the solvent process is tested for flashpoint. If “clean water” from the solvent process is found to have a flashpoint >141 degree F it is passed to the wastewater pre-treatment process for further processing and disposal as described above.

Previously, the difficult waste oil streams were transported to landfills for solidification, a timely, costly, and somewhat environmentally undesirable disposition of the difficult waste oil streams. The “rag layer” (water, oil, and solids) which is about 50% oil was sent off into the used fuel market without further processing. In the wastewater and used solvent treatment process, the difficult waste oil streams and the “rag layer” of water, oil, and solids are sent to the used solvent process for further processing with used or spent solvents.

Used Solvent Process

Used solvent is stored in one or more used solvent storage tanks. In the exemplary embodiment of the used oil used solvent treatment process described herein, two 10,000 gallon used solvent storage tanks are used. The difficult waste oil streams and the “rag layer” of water, oil, and solids are combined in a process tank at a 20-80% concentration by volume with the used solvents and slowly mixed. The difficult waste oil streams and the “rag layer” of water, oil, and solids may be treated with spent solvents together or separately. The mixing is stopped and a resulting mixture of used oils and solvents in the process tank is allowed to separate into a top layer of oil and solvent floating at the top of the process tank and a bottom layer of solids at the bottom of the process tank.

A middle layer of what is referred to as a “clean water” is between the top layer of oil and solvent and the bottom layer of the solids in the process tank. Oil and solvent from top layer are transported offsite to the fuels or commodity products markets. The remaining “clean water” in the middle layer is tested for flashpoint and if the “clean water” from the solvent process is found to have an acceptable flashpoint, which in the exemplary embodiment is greater than 141 degree F., it is passed to the waste water pre-treatment system unit for further processing and disposal as described above. The solids from the bottom layer in the process tank are filtered and sent offsite to a landfill.

The present invention has been described in an illustrative manner. It is to be understood that the terminology which has been used is intended to be in the nature of words of description rather than of limitation. While there have been described herein, what are considered to be preferred and exemplary embodiments of the present invention, other modifications of the invention shall be apparent to those skilled in the art from the teachings herein and, it is, therefore, desired to be secured in the appended claims all such modifications as fall within the true spirit and scope of the invention.

Accordingly, what is desired to be secured by Letters Patent of the United States is the invention as defined and differentiated in the following claims:

What is claimed is:

1. A wastewater treatment method comprising mixing spent solvents with an oily water stream comprising water, oil, and solids and separating a resulting mixture into a top layer of oil and solvent, a middle layer of clean water, and a bottom layer of solids.

2. The method of claim 1 further comprising combining the spent solvents with the oily water stream at a 20-80% concentration by volume before or during the mixing.

3. The method of claim 2 further comprising combining the spent solvents with the oily water stream in a process tank and performing the mixing and the separating in the process tank.

4. The method of claim 1 further comprising transporting the top layer of oil and solvent offsite into the fuels or commodity products markets and sending the bottom layer of solids offsite to a landfill.

5. The method of claim 4 further comprising testing the clean water in the middle layer for flashpoint and if the clean water from the solvent process is found have an acceptable flashpoint processing it in a wastewater pre-treatment process and sending it to a municipal water treatment plant for final treatment and discharge into the environment.

6. A wastewater treatment method comprising:
separating an oily water stream into at least three distinct layers;
the three distinct layers including a top layer of clean oil, a middle layer comprising a mixture of water, oil, and solids, and a bottom layer of clean water;
mixing spent solvents with the middle layer mixture of water, oil, and solids to form a mixture of used oils and solvents;
separating the mixture of used oils and solvents into a top layer of oil and solvent, a middle layer of clean water, and a bottom layer of solids.

7. The method of claim 6 further comprising heat treating and chemically treating the oily water stream to chemically break a suspension of oils from water in the oily water stream before separating the oily water stream.

8. The method of claim 6 further comprising combining the spent solvents with the oily water stream at a 20-80% concentration by volume before or during the mixing.

9. The method of claim 8 further comprising combining the spent solvents-with the oily water stream in a process tank and performing the mixing and the separating in the process tank.

10. The method of claim 7 further comprising transporting the top layer of oil and solvent offsite into the fuels or commodity products markets and sending the bottom layer of solids offsite to a landfill.

11. The method of claim 10 further comprising testing the clean water in the middle layer for flashpoint and if the clean water from the solvent process is found have an acceptable flashpoint processing it in a wastewater pre-treatment process and sending it to a municipal water treatment plant for final treatment and discharge into the environment.

12. A wastewater treatment method comprising:
an oily water treatment process followed by a used solvent process;
the oily water treatment process comprising straining an untreated oily water stream and forming a strained oily water stream;
testing the strained oily water stream to determine if it is suitable to be heat and/or chemically treated;
heat and/or chemically treating the strained oily water streams determined suitable;
separating the heat and/or chemically treated oily water streams into at least three distinct layers;
the three distinct layers including a top layer of clean oil, a middle layer comprising a mixture of water, oil, and solids, and a bottom layer of clean water;
the used solvent process comprising mixing spent solvents with a strained oily water stream deemed not suitable to be heat and/or chemically treated during the testing and not heat and/or chemically treated, and/or the middle layer mixture of water, oil, and solids to form a mixture of used oils and solvents; and
separating the mixture of used oils and solvents into a top layer of oil and solvent, a middle layer of clean water, and a bottom layer of solids.

13. The method of claim 12 further comprising combining the spent solvents with the oily water stream at a 20-80% concentration by volume before or during the mixing.

14. The method of claim 13 further comprising combining the spent solvents with the oily water stream in a process tank and performing the mixing and the separating in the process tank.

15. The method of claim 12 further comprising transporting the top layer of oil and solvent offsite into the fuels or commodity products markets and sending the bottom layer of solids offsite to a landfill.

16. The method of claim 15 further comprising testing the clean water in the middle layer for flashpoint and if the clean water from the solvent process is found have an acceptable flashpoint processing it in a wastewater pre-treatment process and sending it to a municipal water treatment plant for final treatment and discharge into the environment.

17. The method of claim 12 further comprising the heat and/or chemically treating including heating the strained oily water streams determined suitable to between 150 and 200 degrees F.

18. The method of claim 17 further comprising the heat and/or chemically treating including chemically treating the strained oily water streams with chemicals for chemically breaking a suspension of oils from water in the strained oily water stream.

19. The method of claim 18 further comprising combining the spent solvents with the oily water stream at a 20-80% concentration by volume before or during the mixing.

20. The method of claim 19 further comprising combining the spent solvents with the oily water stream in a process tank and performing the mixing and the separating in the process tank.

21. The method of claim 20 further comprising transporting the top layer of oil and solvent offsite into the fuels or commodity products markets and sending the bottom layer of solids offsite to a landfill.

22. The method of claim 21 further comprising testing the clean water in the middle layer for flashpoint and if the clean water from the solvent process is found have an acceptable flashpoint processing it in a wastewater pre-treatment process and sending it to a municipal water treatment plant for final treatment and discharge into the environment.
